(19) United States
(12) Patent Application Publication
(10) Pub. No.: US 2007/0287872 A1
(43) Pub. Date: Dec. 13, 2007

(54) Tungsten Based Catalyst System

(76) Inventors: Robert Paul Tooze, Scotland (GB); Martin John Hanton, Scotland (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/593,066

(22) PCT Filed: Mar. 11, 2005
(86) PCT No.: PCT/GB05/00948

§ 371 Date: Jul. 30, 2007

(30) Foreign Application Priority Data
Mar. 17, 2004 (GB) 0406039.8

(51) Int. Cl. B01J 31/00

(52) U.S. Cl. 585/601; 502/167; 556/57; 585/899

(57) ABSTRACT

A catalyst system including the combination of a source of tungsten; a ligand precursor containing at least N or O as a bonding atom to bond to the tungsten in the source of tungsten, the source of tungsten and the ligand precursor being selected to form an acid due to the bonding of the ligand precursor to the tungsten; and the catalyst system being characterized therein that it is substantially free of the acid formed due to the bonding of the ligand precursor to the tungsten; and that the molar ratio of the tungsten in the source of tungsten to ligand precursor is at least 1:3/n where n is the number of bonds that the ligand precursor forms with the tungsten.

### FIELD OF THE INVENTION

This invention relates to a catalyst system, the preparation thereof and the use thereof in the dimerisation of olefins.

### BACKGROUND ART

Catalyst systems based on tungsten and aluminium activators are described in U.S. Pat. No. 3,784,629; U.S. Pat. No. 3,784,630; U.S. Pat. No. 3,784,631; U.S. Pat. No. 3,813,453; U.S. Pat. No. 3,897,512; U.S. Pat. No. 3,903,193 and J. Org. Chem., 1975, 40, 2983-2985. The use of such catalyst systems in the dimerisation of light olefins is also known.

U.S. Pat. No. 5,059,739 describes a catalyst system for olefin dimerisation and codimerisation prepared in situ by the reaction of a tungsten precursor with an aniline ligand in a 1:1 molar ratio at reflux in chlorobenzene under a flow of an inert gas to remove HCl evolved from the system. After completion of this reaction an aluminium activator was added to the mixture. The resulting catalyst system was used in the dimerisation and codimerisation of butene and lighter olefins. The branching selectivities within the dimer fraction observed with this system employing propene as substrate range from mono-branched 14% and di-branched 85% through to mono-branched 21% and di-branched 79%. (See also comparative example A).

J. Mol. Cat. A., Chem, 1999, 148, 43-48 also discloses a catalyst system with a tungsten to aniline ligand molar ratio of 1 to 1. The catalyst system was used to dimerise light olefins in the form of propene and ethene. The highest selectivity to mono-branching observed with the catalysts systems employed within this publication is mono-branched 41% and di-branched 59%.

The present inventors have now developed a novel catalyst system which is distinguished over the prior art in that a different tungsten to ligand molar ratio is used in combination with the removal or neutralisation of acid formed by the reaction of a ligand precursor and a source of tungsten.

This catalyst system is particularly suitable for use in the dimerisation of olefins and it has also been found that the catalyst influences the regioselectivity of the reaction.

### DISCLOSURE OF THE INVENTION

According to a first aspect of the present invention there is provided a catalyst system including the combination of
a source of tungsten;
a ligand precursor containing at least N or O as a bonding atom to bond to the tungsten in the source of tungsten, the source of tungsten and the ligand precursor being selected to form an acid due to the bonding of the ligand precursor to the tungsten;
   and the catalyst system being characterized therein that it is substantially free of the acid formed due to the bonding of the ligand precursor to the tungsten; and that the molar ratio of the tungsten in the source of tungsten to ligand precursor is at least 1:3/n where n is the number of bonds that the ligand precursor forms with the tungsten.
   Acid Free

The acid formed due to the bonding of the ligand precursor to the tungsten may be removed or neutralised in any suitable manner. Where the formed acid comprises HCl it may be removed by an inert gas stream as described in U.S. Pat. No. 5,059,739 which is incorporated herein by reference.

In a preferred embodiment of the invention the formed acid is neutralised by the addition of a base. Accordingly the catalyst system may comprise a combination of the said source of tungsten; said ligand precursor; and a base.

The base may comprise any suitable base for neutralizing the acid formed. The base may comprise a Brønsted base. A Brønsted base will be understood to be a base as defined by J. N. Brønsted, Recl. Trav. Chim. Pays-Bas, 1923, 42, 718-728 and T. M. Lowry, Chem. Ind. London, 1923, 42 and 43. The base may be an organic base, preferably an amine, preferably a tertiary amine, preferably triethylamine.

The base may comprise aniline or a substituted aniline.

The amount of the base to be added will depend on the type of ligand precursor and more particularly the amount of acid produced by the reaction of the ligand precursor with the source of tungsten. Preferably sufficient base is added to neutralize substantially all the acid formed. Preferably the molar ratio of the base:ligand precursor is at least 1 (m/p):1, where m is the molar amount of acid produced due to the reaction of 1 mole of ligand precursor with 1 mole of the source of tungsten, and p is the molar amount of acid formed neutralised by 1 mole of base. Preferably said base:ligand molar ratio is from 1 (m/p):1 to 20 (m/p):1; preferably from 1 (m/p):1 to 2 (m/p):1.

Ratio of Source of Tungsten to Ligand Precursor:

As stated above the molar ratio of the tungsten in the source of tungsten to ligand precursor is at least 1:3/n, where n is the number of bonds that the ligand precursor forms with the tungsten. Preferably said molar ratio is 1:4/n preferably not higher than 1:10/n and more preferably it is not higher than 1:5/n. In a preferred embodiment of the invention the said ratio is about 1:4/n.

For example with WCl₆ as the source of tungsten and with aniline (PhNH₂) as the ligand precursor the molar ratio of the tungsten in the source of tungsten to ligand precursor is preferably 1:2, as aniline forms a double bond with the tungsten in WCl₆.

It will be appreciated that the present invention is not limited to any specific compound formed due to the reaction between the source of tungsten and the ligand precursor and n is the expected number of bonds to form between the source of tungsten and the ligand precursor. Without being bound thereto, it is believed that the species LₙWL′₂ is preferably formed due to the combination of the tungsten source with the ligand precursor, where L is the ligand from the ligand precursor and L′ is any group which may leave the complex when reacted with an activator or displaced by an olefinic moiety.

Source of Tungsten:

The source of tungsten may comprise any suitable source of tungsten, preferably with the tungsten in the 6⁺ oxidation state. The source of tungsten may comprise an organic salt of tungsten, an inorganic salt of tungsten or an organometallic complex of tungsten.

Preferably the source of tungsten comprises a salt of tungsten, preferably a salt of the formula WXₙ, where X is any suitable anion (X being the same or different where n>1) and n=1 to 6. Preferably X is selected from halide, oxo, amide anion, organyl (including alkyl and aryl), —(organyl) (including alkoxy) or OTf (trifluoromethanesulfonyl), methanesulfonyl, OTos (p-toluenesulphonyl). Preferably the source of tungsten is a tungsten halide, preferably a tungsten chloride, preferably WCl₆.

The Ligand Precursor:

In a preferred embodiment of the invention the ligand precursor may include only N and/or O as bonding atoms to bond to the tungsten. In one embodiment of the invention the ligand precursor may include only two such bonding atoms which atoms are in the form of N and/or O and which may be the same or different in which case the ligand precursor may define a bidentate ligand. In an alternative embodiment of the invention the ligand precursor may include a single such bonding atom which atom is in the form of N or O in which case the ligand precursor may form a monodentate ligand.

The bonding atoms of the ligand precursor may be electron donating atoms to form a coordination compound with the source of tungsten.

The ligand precursor may be a compound or may be a compound including a moiety selected from the group consisting of a carboxylic acid; an alcohol; a diketone; and an amine. Preferably it comprises an amine.

The ligand precursor preferably includes an aromatic or heteroaromatic moiety, preferably an aromatic moiety.

The ligand precursor may comprise a bidentate ligand precursor such as an aromatic or heteroaromatic bidentate ligand precursor said bidentate ligand precursor may for example comprise a substituted or non-substituted diaminonaphtalene, such as 1,8-diaminonaphtalene. Alternatively the bidentate ligand precursor may be selected from the group consisting of H₂NANH₂, R′(H)NANH₂, R′(H)NAN(H)R″, H₂NAOH, R′ (H)NAOH, HOAOH, HOA=O and O=A=O, where A is a bond or a bridging group of one to 10 spacer atoms, and R′ and R″ are independently an organic moiety, preferably an organyl group, preferably an aromatic group.

Preferably the ligand precursor comprises a monodentate ligand precursor, preferably a compound of the formula R¹_{q}NH_{3-q}, wherein q is from 1-2 and R¹ is an organic moiety, preferably an organyl group and R¹ being the same or different when q=2. Preferably at least one R¹ group is an aromatic compound. The ligand precursor may comprise an aromatic amine such as aniline or a substituted aniline.

Mixtures of different monodentate ligand precursors may be used, as may mixtures of different bidentate ligand precursors or mixtures of monodentate and bidentate ligand precursors.

Activator

The catalyst systems may also include an activator of the catalyst system. These activators may be reducing agents.

In one embodiment of the invention the activator may comprise a compound containing a Group 3A atom, and preferably the Group 3A atom is Al or B.

Aluminium compounds that may be suitable are compounds such as R²ₙAlX₃₋ₙ, wherein n=0 to 3; wherein X is halide; and wherein R² is an organic moiety, R² being the same or different when n>1. Preferably R² is independently an organyl group (including alkyl, aryl); an oxygen containing moiety (such as alkoxy or aryloxy). Examples include trimethylaluminum (TMA), triethylaluminum (TEA), tri-isobutylaluminum (TIBA), tri-n-octylaluminum, methylaluminum dichloride, ethylaluminum dichloride, dimethylaluminum chloride, diethylaluminuim chloride, aluminium isopropoxide, ethylaluminiumsesquichloride, methylaluminum-sesquichloride, and aluminoxanes. Aluminoxanes are well known in the art as typically oligomeric compounds which can be prepared by the controlled addition of water to an alkylaluminium compound (for example trimethylaluminum, to give methylaluminoxane (MAO) or triethylaluminum to give ethylaluminoxane (EAO).

Such compounds can be linear, cyclic, cages or mixtures thereof. Mixtures of different aluminoxanes may also be used in the process.

It should be noted that aluminoxanes generally also contain considerable quantities of the corresponding trialkylaluminum compounds used in their preparation. The presence of these trialkylaluminum compounds in aluminoxanes can be attributed to their incomplete hydrolysis with water. Any quantity of a trialkylaluminum compound quoted in this disclosure is additional to alkylaluminium compounds contained within the aluminoxanes.

The activator may be selected from alkylaluminoxanes such as methylaluminoxane (MAO) and ethylaluminoxane (EAO) as well as modified alkylaluminoxanes such as modified methylaluminoxane (MMAO). Modified methylaluminoxane (a commercial product from Akzo Nobel) contains modifier groups such as isobutyl groups, in addition to methyl groups. However in one preferred embodiment the activator comprises ethylaluminum dichloride.

Examples of suitable boron activator compounds are boroxines, NaBH₄, triethylborane, tris(pentafluorophenyl)borane, lithium tetrakis(pentafluorophenyl) borate, ammonium and ethereal borate salts (e.g. [{Et₂O}₂H][B(C₆F₅)₄], [Ph₂MeNH][B(C₆F₅)₄]), tributyl borate and the like.

The activator may also be or contain a further compound that acts as a reducing agent, such as sodium or zinc metal and the like. Other activators that can be used include alkyl or aryl zinc and lithium reagents.

The activator and the source of tungsten may be combined in molar ratios of Al:W or B:W from about 3.5:1 to 1000:1, preferably from about 4:1 to 50:1, and more preferably from 5:1 to 25:1.

Method

The invention also relates to a method of preparing a catalyst system comprising the steps of combining
a source of tungsten;
a ligand precursor containing at least N or O as a bonding atom to bond to the tungsten in the source of tungsten, the source of tungsten and the ligand precursor being selected to form an acid due to the bonding of the ligand precursor to the tungsten;
   wherein the molar ratio of the tungsten in the source of tungsten to ligand precursor is at least 1:3/n, where n is the number of bonds that the ligand precursor forms with the tungsten; and the method including the step of removal or neutralisation of acid formed due to the bonding of the ligand precursor to the tungsten.

Preferably the said formed acid is neutralised by the addition of a base.

Preferably the process also includes the step of adding an activator for activating the catalyst system.

The source of tungsten, ligand precursor and base may be combined in any order and preferably thereafter the activator is added.

The components of the catalyst system may be mixed, preferably at a temperature from −20 to 200° C., more preferably 0 to 70° C.

The invention also relates to a catalyst system prepared by the method as set out above.

Catalyst System Applications:

According to another aspect of the present invention there is provided the use of the catalyst system substantially as herein described to dimerise or codimerise one or more olefinic compounds in the form of olefins or compounds including an olefinic moiety.

It has been found that the catalyst system is particularly useful to prepare a mono-methyl branched dimerised product (especially a mono branched mono methyl branched dimerised product) especially of α-olefins including α-olefins with five or more carbon atoms, such as 1-hexene which is an α-olefin with six carbon atoms. It has also been found that this catalyst system influences the regioselectivity of dimerisation reactions.

Accordingly to another aspect of the present invention there is provided a process for the dimerisation of a starting olefinic compound or codimerisation of different starting olefinic compounds, each starting olefinic compound being in the form of an olefin or a compound that includes an olefinic moiety, the process comprising the steps of mixing at least one starting olefinic compound with a catalyst system substantially as described herein above to form a dimerised product of a starting olefinic compound or a codimerised product of different starting olefinic compounds.

The catalyst system may be pre-prepared, but preferably the catalyst system is formed in situ during mixing with the at least one starting olefinic compound.

Each starting olefinic compound preferably includes an α-olefinic moiety and preferably each starting olefinic compound comprises an α-olefin. In one embodiment of the invention an α-olefin of five or more carbon atoms is dimerised, preferably the starting olefin has only one double bond between carbon atoms and in one embodiment of the invention the starting olefin is 1-hexene.

Preferably the dimerised or codimerised product has only a single branch formed due to the dimersation, and preferably this branch is a methyl branch. In a preferred embodiment of the invention the starting compound is dimerised to a mono branched, preferably a mono-methyl mono-branched dimerisation product. Preferably the starting olefinic compound is linear. In the case where 1-hexene is the starting olefinic compound the dimerisation product may be 5-methylundecenes (mixture of isomers in terms of position of unsaturation). In a preferred embodiment of the invention the reaction produces a reaction product containing more than 50 wt % of the mono branched mono-methyl product, preferably more than 60 wt %. Preferably the reaction is regioselective to form a mono branched mono-methyl dimerisation product of the starting olefinic compound.

The process may be carried out in a solvent. The solvent may be part of the starting olefinic compound(s) but preferably the solvent is an inert solvent which does not react with the catalyst system. Such an inert solvent may for example comprise benzene, toluene, chlorobenzene, xylene, cumene, tert-butyl-benzene, sec-butylbenzene, heptane, methylcyclohexane, methylcyclopentane, cyclohexane, ionic liquid and the like.

The process may be carried out at temperatures from −20° C. to 200° C. It will be appreciated that the choice of solvent and starting olefinic compound may determine a suitable temperature range for the process. Temperatures in the range of 0-70° C. are preferred, more preferably in the range from 20 to 60° C.

The starting olefinic compound may be contacted with the catalyst system at any pressure.

According to another aspect of the present invention there is provided a dimerised product or co-dimerised product produced by the process substantially as described hereinabove.

### EXAMPLES

The invention will now be further described by means of the following non-limiting examples.

### Example 1

A stirred reaction vessel (dried under vacuum at elevated temperature and back-filled with inert gas [Ar or N₂]) was charged with a source of tungsten in the form of WCl₆ (0.1 mmol), chlorobenzene solvent (10 ml), nonane (standard), Et₃N (0.4 mmol) as a base, aniline (PhNH₂) (0.2 mmol) as ligand precursor and 1-hexene as a starting olefinic compound (100 mmol) and heated to 60° C. for 15 minutes. The catalysis was then initiated by addition of ethylaluminum dichloride (EADC) (1.1 mmol), and the vessel stirred at 60° C. for 4 hours.

The run was terminated by addition of 2 ml of a MeOH/H₂O (50:1) solution and stirring for 5 minutes. Subsequently, distilled water (50 ml) was added and the mixture vigorously stirred, then allowed to separate and the organic layer separated and filtered. The organic layer was analysed by GC. An activity of 107.2 (mol olefin)(mol W)⁻¹ hr⁻¹ with a TON of 428.7 (mol 1-C₆)(mol M)⁻¹ was calculated for this experiment. The product composition of the reaction mixture at the end of the test (in terms of hydrocarbon fractions) was C₁₂ (87.8 wt %), C₁₈, (1.3 wt %) and heavies, ≧[C₂₄], (10.9 wt %).

The skeletal selectivity (determined after hydrogenation of the olefinic dimer product—see Example 8) within the C₁₂ (dimer) fraction is: linear product 0 wt %; mono-methylbranched product (as 5-methylundecenes) 65 wt %; di-methylbranched product (as 5,6-dimethyldecenes) 35 wt %.

It was found that when the base triethylenediamine (DABCO™) was used as a base instead of Et₃N under the same conditions as in this example the results achieved were less favourable.

### Example 2

The representative procedure described in example 1 was used, except 4-fluoroaniline (0.2 mmol) was used in place of aniline.

The product composition of the reaction mixture at the end of the test (in terms of hydrocarbon fractions) was C₁₂ (94.0 wt %), C₁₈, (1.2 wt %) and heavies, ≧[C₂₄], (4.8 wt %). The skeletal selectivity determined within the C₁₂ (dimer) fraction is: linear product 0 wt %; mono-methylbranched product ˜65 wt %; di-methylbranched product ˜35 wt %.

### Example 3

The representative procedure described in example 1 was used, except p-toluidine (0.2 mmol) was used in place of aniline.

The product composition of the reaction mixture at the end of the test (in terms of hydrocarbon fractions) was C₁₂ (66.8 wt %), C₁₈, (0.0 wt %) and heavies, ≧[C₂₄], (33.2 wt %). The skeletal selectivity determined within the C₁₂ (dimer) fraction is: linear product 0 wt %; mono-methylbranched product ˜65 wt %; di-methylbranched product ˜35 wt %.

### Example 4

The representative procedure described in example 1 was used, except 1,8-diaminonapthalene (0.1 mmol) was used in place of aniline.

The product composition of the reaction mixture at the end of the test (in terms of hydrocarbon fractions) was C₁₂ (10.1 wt %), C₁₈, (0.0 wt %) and heavies, ≧[C₂₄], (89.9 wt %). The skeletal selectivity determined within the C₁₂ (dimer) fraction is: linear product 0 wt %; mono-methylbranched product ˜65 wt %; di-methylbranched product ˜35 wt %.

### Example 5

A stirred reaction vessel (dried under vacuum at elevated temperature and back-filled with inert gas [N₂]) was charged with a source of tungsten in the form of WCl₆ (0.1 mmol), chlorobenzene solvent (12 ml), nonane (standard), Et₃N (0.3 mmol) as a base, aniline (PhNH₂) (0.1 mmol) as ligand precursor, phenol (PhOH) (0.1 mmol) as ligand precursor and 1-hexene as a starting olefinic compound (100 mmol) and heated to 60° C. for 15 minutes. The catalysis was then initiated by addition of ethylaluminum dichloride (EADC) (1.1 mmol), and the vessel stirred at 60° C. for 1 hour.

The run was terminated and was followed-up with work up as set out in Example 1. The organic layer was analysed by GC. An activity of 36.6 (mol 1-C₆)(mol M)⁻¹ hr⁻¹ with a TON of 36.6 (mol olefin)(mol W)⁻¹ was calculated for this experiment. The product composition of the reaction mixture at the end of the test (in terms of hydrocarbon fractions) was C₁₂ (49.2 wt %), C₁₈, (1.1 wt %) and heavies, ≧[C₂₄], (49.7 wt %).

### Example 6

A stirred reaction vessel (dried under vacuum at elevated temperature and back-filled with inert gas [N₂]) was charged with a source of tungsten in the form of WCl₆ (0.1 mmol), chlorobenzene solvent (40 ml), nonane (standard), Et₃N (0.4 mmol) as a base, aniline (PhNH₂) (0.2 mmol) as ligand precursor and 1-heptene as a starting olefinic compound (250 mmol) and heated to 30° C. for 30 minutes. The catalysis was then initiated by addition of ethylaluminum dichloride (EADC) (1.2 mmol), and the vessel stirred at 20° C. for 24 hours.

The run was terminated by addition of 2 ml of a MeOH/H₂O (50:1) solution and stirring for 5 minutes. Subsequently, distilled water (50 ml) was added and the mixture vigorously stirred, then allowed to separate and the organic layer separated and filtered. The organic layer was analysed by GC. A TON of 1606.6 (mol olefin)(mol W)⁻¹ was calculated for this experiment. The product composition of the reaction mixture at the end of the test (in terms of hydrocarbon fractions) was C₁₄ (98.4 wt %), C₂₁, (0.2 wt %) and heavies, ≧[C₂₈], (≧1.4 wt %).

The skeletal selectivity (determined after hydrogenation of the olefinic dimer product—see Example 5) within the C₁₄ (dimer) fraction is: linear product 0 wt %; mono-methylbranched product 64.4 wt %; di-methylbranched product 35.6 wt %.

### Example 7

A stirred reaction vessel (dried under vacuum at elevated temperature and back-filled with inert gas [N₂]) was charged with a source of tungsten in the form of WCl₆ (0.1 mmol), chlorobenzene solvent (20 ml), nonane (standard), Et₃N (0.4 mmol) as a base, aniline (PhNH₂) (0.2 mmol) as ligand precursor and the vessel was heated to 60° C. for 30 minutes, then cooled to 23° C. Two olefin feedstocks-1-pentene (10 mmol) and 1-nonene (10 mmol) were then added to the reaction vessel. The catalysis was then initiated by addition of ethylaluminum dichloride (EADC) (1.2 mmol), and the vessel stirred at 23° C. for 4 hours.

The run was terminated by addition of 2 ml of a MeOH/H₂O (50:1) solution and stirring for 5 minutes. Subsequently, distilled water (50 ml) was added and the mixture vigorously stirred, then allowed to separate and the organic layer separated and filtered. The organic layer was analysed by GC.

A total TON of 161.4 (mol olefin)(mol W)⁻¹ was calculated for this experiment. The product composition of the reaction mixture at the end of the test (in terms of dimer hydrocarbon fractions) was C₁₀ (29.0 mol %), C₁₄, (46.0 mol %) and C₁₈ (25.0 mol %). The branching selectivity within each of the dimer fractions (determined after hydrogenation) was C₁₀ (36% di-methyl branched, 64% mono-methyl branched), C₁₄ (36% dimethyl branched, 64% mono-methyl branched, C₁₈ (40% di-methyl branched, 60% mono-methyl branched).

### Example 8

A sample of the organic layer recovered from example 1 was reduced under vacuum to leave the dimerised olefinic product as essentially the main component (traces of chlorobenzene and nonane persisted) and filtered. This was then hydrogenated as a solution in alcohol (equal volume, ethanol) using Pd/C (Degussa type E1002 XU/W, 0.5 g of 5% Pd/C per 100 mmol of olefin moiety) under H₂ (20 bar), 18 hours. The solution was filtered and GC analysis obtained.

The GC+ ¹³C NMR analysis showed that a single major paraffinic product resulted from hydrogenation namely 5-methyl-undecane:

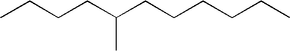

The paraffinic product was also analysed by ¹³C {¹H} pendant NMR spectroscopy. The chemical shifts observed agree with those predicted by theory for 5-methyl-undecane.

### Comparative Example A

### U.S. Pat. No. 5,059,739 Method of Catalyst Preparation

A stirred reaction vessel (dried under vacuum at elevated temperature and back-filled with inert gas [N₂]) was charged with a source of tungsten in the form of WCl₆ (0.1 mmol), chlorobenzene solvent (10 ml), nonane (standard), aniline (PhNH₂) (0.1 mmol) as ligand precursor and the vessel was stirred and heated to reflux (˜132° C.) for 60 minutes under a constant flow/purge of nitrogen. After this time the vessel was cooled to 25° C. and 1-pentene (100 mmol) added to the reaction vessel. The catalysis was then initiated by addition of ethylaluminum dichloride (EADC) (1.1 mmol), and the vessel stirred at 20° C. for 5 hours.

The run was terminated by addition of 2 ml of a MeOH/H₂O (50:1) solution and stirring for 5 minutes. Subsequently, distilled water (50 ml) was added and the mixture vigorously stirred, then allowed to separate and the organic layer separated and filtered. The organic layer was analysed by GC.

A total TON of 581.0 (mol olefin)(mol W)⁻¹ was calculated for this experiment. The product composition of the reaction mixture at the end of the test (in terms of hydrocarbon fractions) was C₁₀ (60.1 mol %), and heavies, ≧[C₁₅], (39.2 wt %). After hydrogenation the skeletal selectivity within the C₁₀ (dimer) fraction is: mono-methylbranched product ˜50 wt %; di-methylbranched product ˜50 wt %.

Discussion of Comparative Example A:

The best selectivity achievable by the inventors was a 50:50 split between di- and mono-branched product, but with concomitant massive heavies formation ˜40%. i.e. a low selectivity to the dimer fraction.

1. A catalyst system including the combination of
a source of tungsten;
a ligand precursor containing at least N or O as a bonding atom to bond to the tungsten in the source of tungsten, the source of tungsten and the ligand precursor being selected to form an acid due to the bonding of the ligand precursor to the tungsten;
and the catalyst system being characterized therein that it is substantially free of the acid formed due to the bonding of the ligand precursor to the tungsten; and that the molar ratio of the tungsten in the source of tungsten to ligand precursor is at least 1:3/n where n is the number of bonds that the ligand precursor forms with the tungsten.

2. The catalyst system of claim 1 wherein the molar ratio of the tungsten in the source of tungsten to ligand precursor is at least 1:4/n.

3. The catalyst system of claim 2 wherein the molar ratio of the tungsten in the source of tungsten to ligand precursor is not higher than 1:5/n.

4. The catalyst system of claim 3 wherein the molar ratio of the tungsten in the source of tungsten to ligand precursor is about 1:4/n.

5. The catalyst system of any one of the preceding claims wherein the tungsten in the source of tungsten is in the 6+ oxidation state.

6. The catalyst system of any one of the preceding claims wherein the source of tungsten is selected from the group of compounds consisting of an organic salt of tungsten; an inorganic salt of tungsten; and an organometallic complex of tungsten.

7. The catalyst system of claim 6 wherein the source of tungsten is a tungsten halide.

8. The catalyst system of any one of the preceding claims wherein the ligand precursor includes only N and/or O as bonding atoms to bond to the tungsten.

9. The catalyst system of claim 8 wherein the ligand precursor includes only two such bonding atoms which atoms are in the form of N and/or O and which are the same or different.

10. The catalyst system of claim 8 wherein the ligand precursor includes a single such bonding atom which atom is in the form of N or O.

11. The catalyst system of claim 10 wherein the ligand precursor is a compound of the formula R¹_{q}NH_{3-q}, wherein q is from 1-2 and R¹ is an organic moiety, R¹ being the same or different when q=2.

12. The catalyst system of claim 11 wherein at least one R¹ group is an aromatic compound.

13. The catalyst system of claim 12 wherein the ligand precursor is a compound selected from the group consisting of aniline and a substituted aniline.

14. The catalyst system of any one of the preceding claims which includes an activator.

15. The catalyst system of claim 14 wherein the activator is a compound containing a Group 3A atom.

16. A method of preparing a catalyst system comprising the steps of combining
a source of tungsten;
a ligand precursor containing at least N or O as a bonding atom to bond to the tungsten in the source of tungsten, the source of tungsten and the ligand precursor being selected to form an acid due to the bonding of the ligand precursor to the tungsten;
wherein the molar ratio of the tungsten in the source of tungsten to ligand precursor is at least 1:3/n, where n is the number of bonds that the ligand precursor forms with the tungsten; and the method including the step of removal or neutralisation of acid formed due to the bonding of the ligand precursor to the tungsten.

17. The method of claim 16 wherein the formed acid is neutralized by the addition of a base.

18. The method of either one of claims 16 or 17 which includes the step of adding an activator for activating the catalyst system.

19. A catalyst system prepared by the method of any one of claims 16 to 18.

20. A process for the dimerisation of a starting olefinic compound or codimerisation of different starting olefinic compounds, each starting olefinic compound being in the form of an olefin or a compound that includes an olefinic moiety, the process comprising the steps of mixing at least one starting olefinic compound with a catalyst system of any one of claims 1 to 15 to form a dimerised product of a starting olefinic compound or a codimerised product of different starting olefinic compounds.

21. The process of claim 20 wherein each starting olefinic compound is an αα-olefin.

22. The process of claim 21 wherein the α-olefin has five or more carbon atoms and has only one double bond between carbon atoms.

23. The process of any one of claims 20 to 22 wherein the dimerised or codimerised product has only a single branch formed due to the dimersation.

24. The process of claim 23 wherein the single benched formed due to dimersation is a methyl branch.

25. A dimerised product or codimerised product produced by the process of any one of claims 20 to 24.

26. The use of a catalyst system of any one of claims 1 to 15, to dimerise or codimerise one or more olefinic compounds in the form of olefins or compounds including an olefinic moiety by mixing at least one starting olefinic compound with the catalyst system of any one of claims 1 to 15 to form a dimerised product of a starting olefinic compound or a codimerised product of different starting olefinic compounds.
